(19) United States
(12) Patent Application Publication
(10) Pub. No.: US 2004/0174152 A1
(43) Pub. Date: Sep. 9, 2004

(54) Pulse-skipping switching power converter

(76) Inventors: Jeffrey H. Hwang, Saratoga, CA (US); Joe Wong, Daly City, CA (US)

Correspondence Address: CHAMPION MICROELECTRONIC CORPORATION, HSINCHU SCIENCE- BASED INDUSTRIAL PARK, 5F, No. 11, PARK AVENUE II, HSINCHU CITY, TW

(21) Appl. No.: 10/379,882

(22) Filed: Mar. 4, 2003

(51) Int. Cl. G05F 1/40

(52) U.S. Cl. 323/284

(57) ABSTRACT

The invention relates to a pulse-skipping power converter. In one aspect, a power converter has two stages. When the load is high, both stages are enabled. As the load decreases, one or both of the stages may enter pulse-skipping mode to improve efficiency. As the load is reduced further, the one or both of the stages may be disabled. When both stages are disabled, an auxiliary power supply may be enabled. In a further aspect, an error signal is produced by comparing a signal representative of an output voltage or current of the power converter relative to a level. A pulse-width modulation (PWM) signal including a series of pulses is produced by comparing the error signal to a ramp signal. The duty cycle of the PWM signal is compared to a reference duty cycle. If the duty cycle of the PWM signal is less then the reference duty cycle then the next pulse in the PWM signal is skipped.

### FIELD OF THE INVENTION

The present invention relates to the field of switching power converters. More particularly, the present invention relates to the control circuitry for power converters with high efficiency while under light loads.

### DESCRIPTION OF THE RELATED ART

A switching power converter is a device that converts an input signal with one power form factor into an output signal with a different power form factor. A switching power converter typically includes a switch, a reactive element, a controller, and a sensor. The sensor feeds a signal into the controller. The controller modulates the input signal by opening and closing the switch in an attempt to make the sensor signal match a reference signal. The reactive element filters the modulated input signal producing a relatively constant output signal.

A typical switch in a switching power converter may be modulated by a Pulse Width Modulation (PWM) signal or a Pulse Frequency Modulation (PFM) signal. A PWM signal has a constant frequency and an adjustable duty cycle. A PFM signal has a constant duty cycle and an adjustable frequency. A typical goal for a power converter is to regulate the output voltage independent of changes in the load or the input voltage. A power converter may do this by measuring an output voltage of the power converter, comparing the output voltage to a reference voltage, and adjusting the duty cycle of the PWM signal or the frequency of the PFM signal to compensate for any discrepancy between the desired output voltage and the measured output voltage.

A typical switching power converter can be a highly efficient device under heavy and medium loads. However, under light loads, a typical switching power converter is often inefficient. One source of this inefficiency stems from the parasitic capacitance and resistance of the switch. One way to increase the efficiency of the power converter is to minimize the use of the switch.

What is needed is an improved technique for pulse-skipping in a switching power converter. It is to these ends that the present invention is directed.

### BRIEF SUMMARY OF THE INVENTION

The invention relates to a pulse-skipping power converter. In one aspect, a power converter has two stages. When the load is high, both stages are enabled. As the power load decreases, one or both of the stages may enter pulse-skipping mode to improve efficiency of the power converter. As the load power is reduced even further, the one or both of the stages may be disabled. When both stages are disabled, an auxiliary power supply (e.g., a linear converter) may be enabled. Disabling one or more of the stages during periods of low power consumption is expected to improve the efficiency of the converter.

In a further aspect of the invention, an error signal is produced by monitoring a signal representative of an output voltage or an output current of the power converter relative to a reference level. A pulse-width modulation (PWM) signal including a series of pulses is produced by comparing the error signal to a ramp signal. The duty cycle of the PWM signal is compared to a reference duty cycle. If the duty cycle of the PWM signal is less then the reference duty cycle then the next pulse in the PWM signal is skipped. These and other aspects of the invention are described in more detail herein.

### BRIEF DESCRIPTION OF DRAWINGS

FIG. 1 illustrates a block diagram of a two-stage power converter in accordance with an aspect of the present invention;

FIG. 2 illustrates the various regions of operation for the two-stage power converter shown in FIG. 1A;

FIG. 3 illustrates a schematic block diagram of an embodiment of a two-stage pulse-skipping power converter;

FIG. 4 illustrates a schematic block diagram of an embodiment of a control circuit for a pulse-skipping PWM power converter;

FIGS. 5-6 illustrate schematic block diagrams of embodiments of low power detectors for use in two-stage pulse-skipping power converters;

FIGS. 7A-D illustrate leading edge timing diagrams for an embodiment of a pulse-skipping power converter;

FIGS. 8A-D illustrate trailing edge timing diagrams for an embodiment of a pulse-skipping power converter;

FIG. 9 illustrates a schematic block diagram of an embodiment of a circuit for producing a clock single with an adjustable duty cycle;

FIG. 10A illustrates a ramp signal that may be used in an embodiment of the current invention;

FIG. 10B illustrates a CLK signal with an adjustable duty cycle, that may be used in an embodiment of the present invention, the period of the CLK is identical to the period of the ramp signal, the falling edge of the CLK signal may be synchronized to the falling edge of the ramp signal; and

FIG. 10C illustrates an inverted CLK signal with an adjustable duty cycle, that may be used in an embodiment of the present invention, the period of the inverted CLK is identical to the period of the ramp signal, the rising edge of the inverted CLK signal may be synchronized to the falling edge of the ramp signal.

### DETAILED DESCRIPTION OF A PREFERRED EMBODIMENT

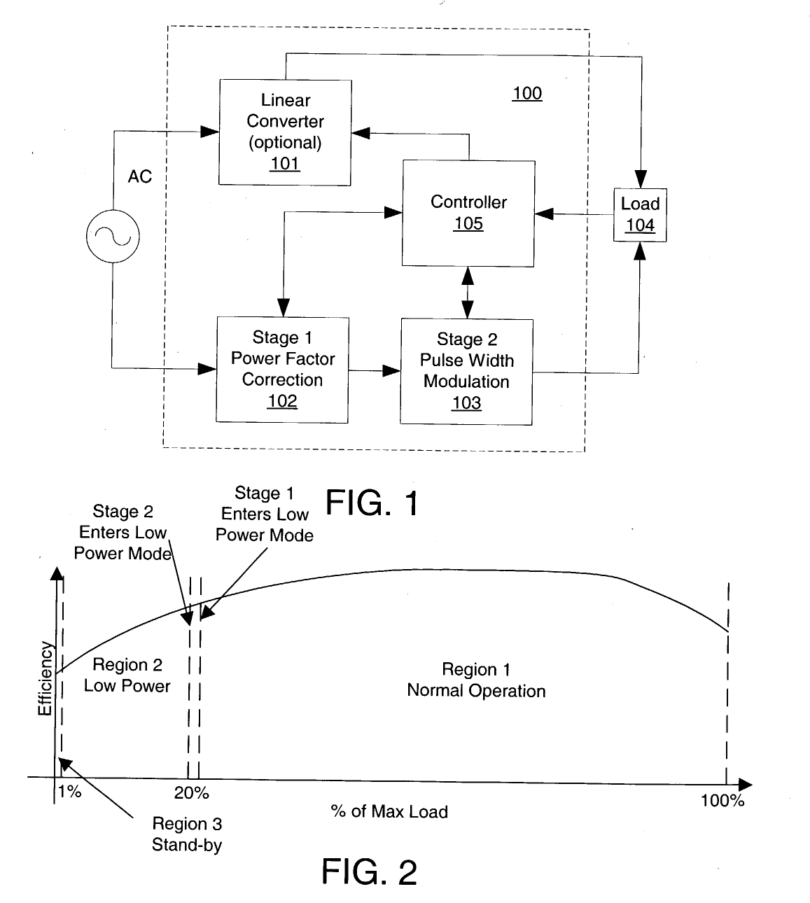

FIG. 1 illustrates a block diagram of a two-stage power converter 100 in accordance with an aspect of the present invention. An AC input signal is coupled to a power factor correction (PFC) stage 102 and an optional linear converter 101. The PFC stage 102 forces the input current to be substantially proportional to the input voltage, while providing a substantially constant intermediate DC output voltage. The intermediate DC output voltage of the PFC stage 102 may be coupled into a PWM stage 103, which produces a regulated output. The output of the PWM stage 103 and an output of the optional linear converter 101 may be coupled to a load 104. A controller 105 may be coupled to the PFC stage 102, the PWM stage 103, the load 104, and the optional linear converter 101.

Thus, the two-stage power converter 100 may be an AC-DC converter in which the first stage 102 may provide power factor correction (PFC), while the second stage 103 may provide output voltage regulation. Assuming the input voltage has a sinusoidal waveform, the PFC stage 102 forces the input current substantially into a sinusoidal waveform in phase with the input voltage.

The controller 105 may sense a signal that is representative of the voltage or current delivered to the load 104. Using this sensed signal and by controlling a switch in PWM stage 103, the controller 105 attempts to maintain a constant output voltage or current. The controller 105 may sense signals that are representative of an input voltage, an input current, an intermediate output voltage of the PFC stage 102; and an output voltage of the PWM stage 103. The controller 105 attempts to maintain a constant output voltage and to insure that the input current is proportional to the input voltage, thereby providing power factor correction. The controller 105 may sense a signal from the load 104 that indicates the level of the power drawn by the load 104. A standby signal from the load 104 may instruct the controller 105 to enter standby mode. For example, where the load 104 is a microprocessor or controller, it may enter a standby or “sleep” mode during periods of low activity for power conservation. While in standby mode, the controller 105 may disable the PFC stage 102. Also, while in standby mode, the controller 105 may cause PWM stage 103 to enter pulse-skipping mode or alternatively may disable the PWM stage 103 and enable the optional linear converter 101.

During low power conditions, pulse-skipping mode may be entered in both stages. Twenty percent of a maximum expected load is a preferred level below which pulse-skipping may be enabled, although other levels may be used. It is expected that output regulation will be minimally affected during pulse-skipping.

During standby conditions, the first stage 102 may be disabled while the second stage 103 may remain in pulse-skipping mode. In an alternate embodiment, both stages may be disabled during standby, and the auxiliary power supply 101 may be enabled. The power converter 100 may enter standby mode below approximately 0.5-1% of maximum load, although other boundary points may be used. It is expected that output and/or input regulation will be minimally affected during standby.

FIG. 2 illustrates a graph that shows modes of operation for the two-stage power converter shown in FIG. 1. The graph shows efficiency versus percentage of maximum expected power drawn by the load. The graph may be divided into approximately three regions. In a first region, Region 1, normal operation occurs. Region 1 may be entered at times when the load power is above approximately 20% of its maximum. In Region 1, the first stage 102 and the second stage 103 may be actively switching. Region 2 may be a low power region and may be entered when the load power is between approximately 0.5-1% and approximately 20% of maximum. As shown in FIG. 2, the first stage 102 and the second stage 103 may enter Region 2 at different levels of load power. For example, the first stage 102 may enter Region 2 at a higher load power level than the second stage 103; alternately, the second stage 102 may enter Region 2 at a higher level. In Region 2, both stages maybe operating in a pulse-skipping mode. Region 3 may be a standby region and may be entered when the load power is below 0.5-1% of its maximum expected load power. In Region 3, the first stage 102 may be disabled, while the second stage 103 may be in its pulse-skipping mode. In an alternate embodiment of the present invention, the first stage 102 and the second stage 103 may be disabled and the auxiliary linear converter 101 may be enabled. The following tables summarize the descriptions given above. More particularly, Table 1 summarizes the first embodiment described above in which the second stage 103 is in its pulse-skipping mode in Region 3, while Table 2 summarizes the alternate embodiment described above in which the second stage 103 is disabled in Region 3.

TABLE 1

| | Region 1 | Region 2 | Region 3 |
|---|---|---|---|
| PFC Stage 1 | On | Pulse-skipping | Off |
| PWM Stage 2 | On | Pulse-skipping | Pulse-skipping |

TABLE 2

| | Region 1 | Region 2 | Region 3 |
|---|---|---|---|
| PFC Stage 1 | On | Pulse-skipping | Off |
| PWM Stage 2 | On | Pulse-skipping | Off |

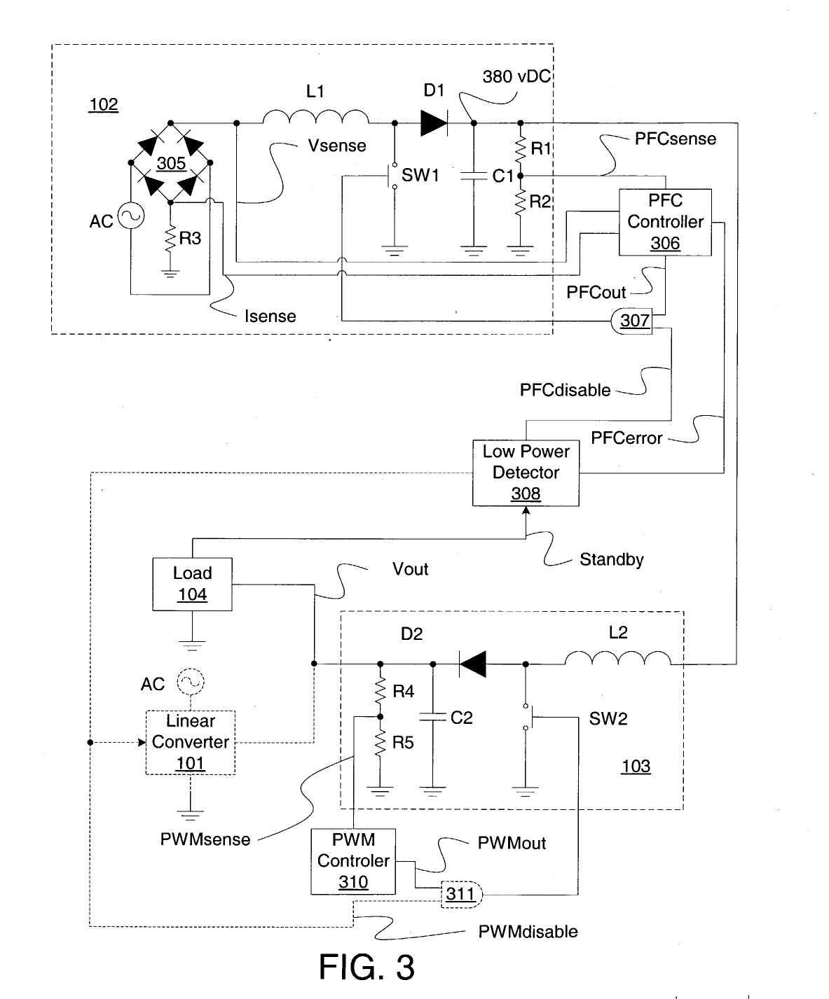

FIG. 3 illustrates an embodiment of the power converter 100 of FIG. 1 in accordance with an aspect of the present invention. The converter of FIG. 3 converts an AC input signal into an output voltage across the load 104. The controller shown in FIG. 1 may include a PFC controller 306, a logic AND gate 307, a low power detector 308, a PWM controller 310, and a logic AND gate 311.

The PFC stage 102 may include a full wave bridge rectifier 305, an inductor L1, a diode D1, a switch SW1, a capacitor C1, and resistors R1, R2 and R3. The AC input signal may be coupled to input terminals of the rectifier 305. A first output terminal of the rectifier 305 may be coupled to a first node of the inductor L1 for delivering the input current and to the PFC controller 306 for delivering a signal Vsense that is representative of the input voltage. A second output terminal of the rectifier 305 may be coupled to a first node of the resistor R3 and to the PFC controller 306 for delivering a signal Isense that is representative of the input current though the inductor L1. A second node of the resistor R3 may be coupled to a ground node. A second node of the inductor L1 may be coupled to a first node of a switch SW1 and an anode of a diode D1. A cathode of the diode D1 may be coupled to a first node of a capacitor C1 and to a first node of resistor R1. A DC intermediate voltage (e.g., 380v) formed at the first node of the capacitor C1 may be fed into the second PWM stage 103. A second node of the resistor R1 may be coupled to a first node of a resistor R2, and to the PFC controller 306 for delivering a signal PFCsense that is representative of the DC intermediate voltage. A second node of the switch SW1, a second node of the capacitor C1, and a second node of the resistor R2 may be coupled to a ground node.

The rectifier 305 may convert a bipolar AC input signal into a unipolar signal. The signals PFCsense, Vsense, and Isense may be coupled into the PFC controller 306. The PFC controller 306 may cause the switch SW1 to be switched on/off in an attempt to cause the AC input current to be substantially proportional to the AC input voltage, and the intermediate output voltage of the PFC stage 102 to remain substantially constant. The inductor L1 and the capacitor C1 act as a filter to reduce ripple in the intermediate output voltage.

The PWM stage 103 may include an inductor L2, a diode D2, a switch SW2, a capacitor C2, and resistors R4 and R5. The intermediate output voltage of the PFC stage 102 may be coupled to a first node of the inductor L2. A second node of the inductor L2 may be coupled to a first node of a switch SW2 and to an anode of the diode D2. A cathode of the diode D2 may be coupled to a first node of the capacitor C2 and to a first node of the resistor R4. An output voltage Vout for powering the load 104 may be formed across the capacitor C2. A second node of the resistor R4 may be coupled to a first node of a resistor R5, and to the PWM controller 310 for delivering a signal PWMsense that is representative of the output voltage Vout. A second node of the switch SW2, a second node of the capacitor C2, and a second node of the resistor R4 may be coupled to a ground node.

The signal PWMsense, representative of the output voltage Vout of the PWM stage 103 may be coupled into the PWM controller 310. The PWM controller 310 may cause the switch SW2 to be switched on and off in an attempt to cause the output voltage Vout to remain substantially constant. The inductor L2 and the capacitor C2 act as a filter to reduce the ripple in the output voltage Vout.

The load 104 may be a smart load in that it may instruct the controller 105 to enter a standby mode. For example, the load 104 may include a microprocessor that may enter a standby mode during periods of low activity or non-use. The load 104 may send a standby signal that may be interpreted by a low power detector 308. The low power detector 308 is thus able to implement the aspects of the invention shown in Region 3 of Table 1 and Table 2. The low power detector 308 may be coupled to the optional linear converter 101, an optional AND gate 311, and an AND gate 307. When the low power detector 308 is instructed to enter standby mode by the load 104, it may send a digital low signal to the AND gate 307, thus disabling switching in the PFC stage 102. The low power detector 308 may also send a digital low signal to the optional AND gate 311, thus disabling the PWM stage 103, while enabling the optional linear converter 101. Alternatively, the linear converter 101, and the AND gate 311 may be omitted, in which case, the PWM stage 103 may not be disabled.

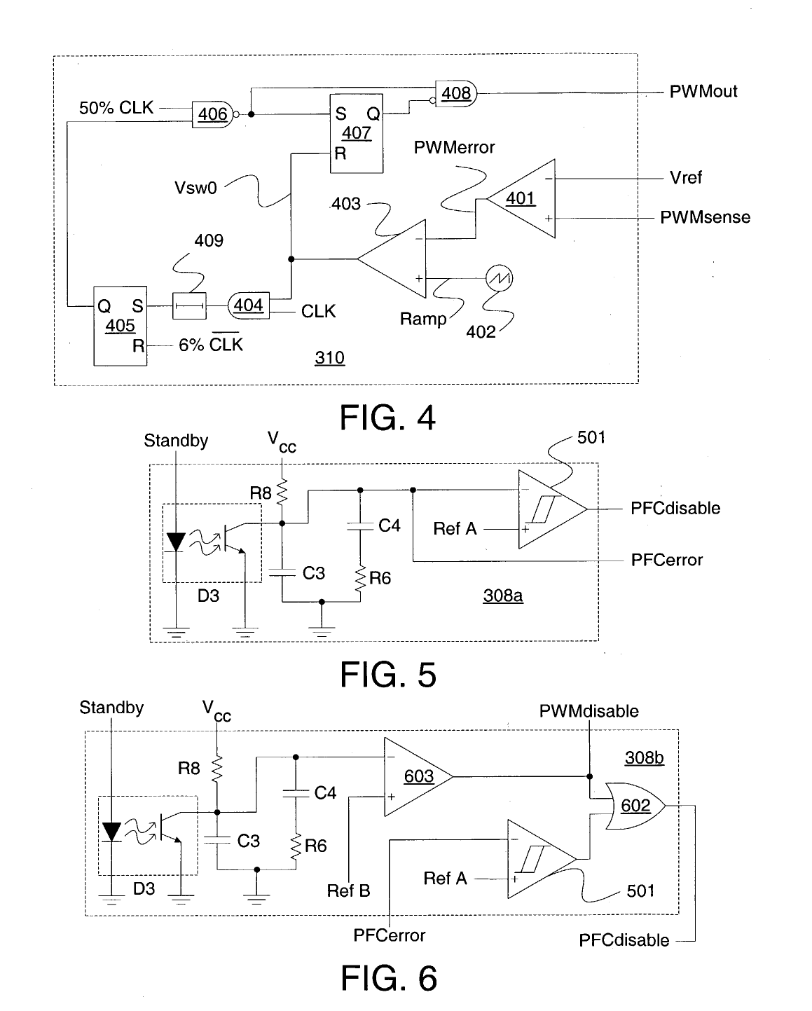

FIG. 4 illustrates an embodiment of the PWM controller 310 in accordance with an aspect of the present invention. The controller 310 may include a differential amplifier 401, a comparator 403, AND gates 404, 406 and 408, and flip-flops 405 and 407. The signal PWMsense that is representative of the output voltage Vout may be coupled to a non-inverting input of a differential amplifier 401. Alternately, to regulate the output current, a signal representative of the output current delivered to the load 104 may be coupled to the non-inverting input of the differential amplifier 401.

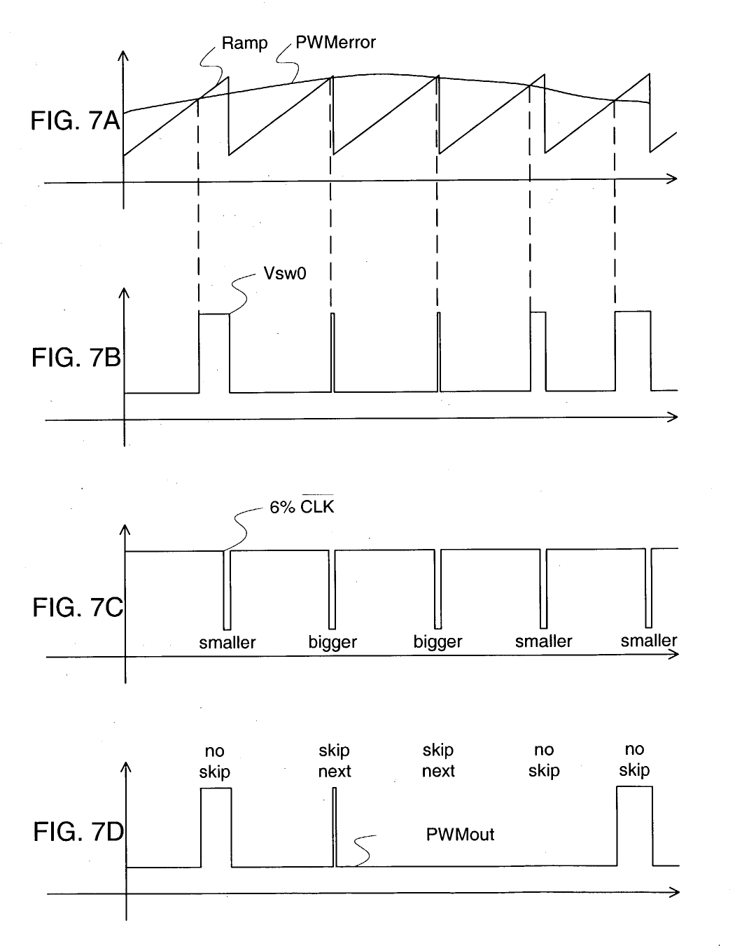

A reference voltage Vref representative of the desired level for the output voltage Vout may be coupled to an inverting input of the differential amplifier 401. The output of the differential amplifier 401 may form an error signal PWMerror. The error signal PWMerror may be representative of a difference between the output voltage Vout and a desired level for the output voltage; as represented by the reference signal Vref. Alternately, PWMerror may be representative of a difference between any signal that is coupled into the inverting input of the differential amplifier 401 and any reference signal Vref. The controller 310 will attempt to minimize PWMerror. The signal PWMerror is shown in FIG. 7A.

Referring to FIG. 4, the error signal PWMerror may be coupled to an inverting input of the comparator 403. An oscillator 402 may produce a ramp signal, Ramp, which is also shown in FIG. 7A. The ramp signal Ramp may be coupled to a non-inverting input of the comparator 403. The output of the comparator 403 may form a PWM signal Vsw0, which is shown in FIG. 7B. The PWM signal Vsw0 is formed by comparing the signals Ramp and PWMerror; the PWM signal Vsw0 may be a logical high voltage when the signal PWMerror is greater then the ramp signal, Ramp, and may be a logical low voltage when the signal PWMerror is lower then the ramp signal, Ramp. Thus, the duty cycle of the PWM signal Vsw0 changes in response to the error signal PWMerror. The duty cycle of the switch SW2 is controlled in response to the signal Vsw0.

The PWM signal Vsw0 may be coupled to a first input of an AND gate 404 and to a RESET input of a flip-flop 407. A clock signal, CLK, that may be synchronized with the ramp signal, Ramp, may be coupled to a second input of the AND gate 404. An output of the AND gate 404 may be coupled to a SET input of the flip-flop 405, through a delay line 409. A 6% \overline{CLK} signal may be an inverted clock signal with a 6% duty cycle, meaning that the signal is low 6% of the time and high the rest of the time, as shown in FIG. 7C. While 6% is a preferred duty cycle, it will be apparent that another duty cycle may be selected. The 6% \overline{CLK} signal may also be synchronized with the ramp signal, Ramp, and may be coupled to a RESET input of the flip-flop 405. The output of the flip-flop 405 may be coupled to a first input of the NAND gate 406. A clock signal 50% CLK, with a duty cycle of 50%, which may be synchronized to the ramp signal, may be coupled to a second input of the NAND gate 406. An output of the NAND gate 406 may be coupled to a SET input of the flip-flop 407 and a first input of an AND gate 408. An output of the flip-flop 407 may be inverted and coupled to a second input of an AND gate 408. An output of the AND gate 408 may be a switch control signal PWMout shown in FIG. 7D which may be used to control the switch SW2. The delay line 409 between the AND gate 404 and the flip-flop 405 synchronizes the first pulse exiting the NAND gate 406 with the second pulse exiting the comparator 403.

The controller 310 implements a pulse-skipping mode. When the power requirements of the load 104 are low, the PWM stage 103 may enter into pulse-skipping mode. The controller 310 may determine when the load is light by comparing the PWM signal Vsw0 (FIG. 7B) to the reference signal with a fixed duty cycle (FIG. 7C). When the duty cycle of the intermediate PWM signal is less then the duty cycle of the reference signal, a next pulse in the PWM signal Vsw0 may be skipped as shown in FIG. 7D. The flip-flop 405 and the AND gate 404 may be used to compare the duty of cycle of the PWM signal to that of the reference signal. The AND gates 406 and 408 and the flip-flop 407 may be used to skip the next pulse. Thus, by comparing FIGS. 7B, 7C and 7D, it can be seen that the signal PWMout in FIG. 7D follows that of the signal Vsw0 in FIG. 7B, except that when a pulse in the signal Vsw0 is bigger (i.e. wider) than the corresponding pulse in the reference signal of FIG. 7C, the next pulse in the signal PWMout is skipped.

FIG. 5 illustrates a first embodiment of the low power detector 308 of FIG. 3, (which is labeled 308a in FIG. 5) in accordance with an aspect of the present invention (represented by Table 1, above). The low power detector 308a may include an opto-coupler D3, capacitors C3 and C4, two resistors R6 & R8, and a comparator 501 that may have hysteresis. A voltage Vcc may be coupled to a first node of the resistor R8. The standby signal from the load 104 may be coupled to an input of the opto-coupler D3. The opto-coupler D3 provides isolation between the load 104 and the detector 308. The opto-coupler D3 may be coupled to a first node of the first capacitor C3, to a first node of the second capacitor C4 a second node R8, and to an inverting input of the comparator 501. A first node of the resistor R6 may be coupled to a second node of the capacitor C4. A second node of the capacitor C3 and a second node of the resistor R6 may be coupled to a ground node. The error signal PFCerror may also be coupled into the inverting input of the comparator 501. A reference voltage Ref A may be coupled to the non-inverting input of the comparator 501.

The low power detector 308a disables the PFC stage 102 in response to receiving the standby signal from the smart load 104. This is accomplished by the opto-coupler D3 pulling the voltage at the inverting input of the comparator 501 below that of Ref A. However, the PWM stage may not be disabled in response to the standby signal as shown in column Region 3 of Table 1 above. The passive elements C3, C4 and R6 act as a low pass filter preventing noise in the standby signal from disabling the PFC stage 102. In addition, when the PFCerror signal falls below the signal Ref A, this indicates that the load has entered Region 2 (FIG. 2) for the PFC stage 102. Accordingly, the PFC stage enters a pulse skipping mode in which pulses in the PFCout signal from the controller 306 (FIG. 3) are skipped so long as the PFCerror signal remains below the level of Ref A. The comparator 501 may optionally exhibit hysteresis so as to reduce the frequency that the PFC enters and exits pulse-skipping mode in the event the PFCerror signal remains near the level of Ref A.

FIG. 6 illustrates an alternate embodiment of the low power detector 308 of FIG. 3 (which is labeled 308b in FIG. 6) in accordance with another aspect of the present invention (represented by Table 2, above). The low power detector 308b may include an opto-coupler D3, two capacitors C3 and C4, two resistors R6 and R8, a comparator 603, an OR gate 602, and a comparator 501 that may have hysteresis. Elements in common with FIG. 5 are given the same reference numeral. A voltage Vcc may be coupled to a first node of the resistor R8. The standby signal from the smart load 104 may be coupled to an input of the opto-coupler D3. The output of the opto-coupler D3 may be coupled to a first node of a capacitor C3, a first node of a second capacitor C4, a second node of a resistor R8 and an inverting input of a comparator 603. A first node of a resistor R6 may be coupled to the capacitor C4. A second node of capacitor C3 and a second node of a resistor R6 may be coupled to a ground node. A reference voltage Ref B may be coupled to a non-inverting input of the comparator 603. An output of the comparator 603 may be coupled to a first input of the OR gate 602, and may form the signal PWMdisable. The error signal PFCerror may be coupled into the inverting input of the comparator 501. The reference voltage Ref A may be coupled to the non-inverting input of the comparator 501. The output of the comparator 501 may be coupled to a second input of the OR gate 602. The OR gate 602 may form a signal PFCdisable.

The passive elements C3, C4 and R6 act as a low pass filter preventing noise in the standby signal from effecting the behavior of the low power detector 308b. The comparator 603 compares the filtered Standby signal to Ref B. When Ref B is higher then the Standby signal, then PWMdisable is high. When Ref B is lower then the Standby signal, then PWMdisable is low. The comparator 501 compares PFCerror to Ref A. When the Ref A is higher then the PFCerror, then the output of the comparator 501 is high. When Ref B is lower then PFCerror then the output of the comparator 501 is low. The logic OR gate 602 causes PFCdisable to be high whenever either the output of comparator 501 is high or PWMdisable is high. Thus, the low power detector 308b disables the PFC stage and the PWM stage and enables the linear converter 101, whenever the detector 308b receives the standby signal from the smart load 104. In addition, the PFC stage 102 skips pulses in the signal PFCout when the signal PFCerror is below Ref A.

FIGS. 7A-D illustrate leading edge timing diagrams of the significant signals in controller 310. The time scales for FIGS. 7A-D are equivalent. FIG. 7A illustrates a timing diagram showing the ramp signal Ramp and the PWMerror signal. The ramp signal Ramp as produced by oscillator 402 may be compared to the PWMerror signal produced by comparator 403 to form the control signal Vsw0 shown in FIG. 7B.

FIG. 7C illustrates the inverted 6% \overline{CLK} that the signal represented in FIG. 7B may be compared to. The text below each pulse states the results of this comparison. The first reference pulse is smaller than the corresponding pulse of Vsw0, the second is bigger, the third is bigger, the fourth is smaller, the fifth is smaller. FIG. 7D illustrates the signal PWMout, of a pulse-skipping controller as may be implemented by the present invention. The text above the waveform states the action that the controller takes given the results of the comparison between the reference signal of FIG. 7C and the PWM signal of FIG. 7B. When the reference signal is smaller then the PWM signal then the next pulse is not skipped. When the reference signal is bigger then the PWM signal then the next pulse is skipped. The text in FIG. 7D illustrates this. For example, the second pulse is not skipped because the first reference pulse is smaller then the first PWM pulse. In addition, the third pulse is skipped because the second reference pulse is smaller then the second PWM pulse. In addition, the fourth pulse is skipped because the third reference pulse is smaller then the third PWM pulse. In addition, the fifth pulse is not skipped because the fourth reference pulse is smaller then the fourth PWM pulse. In addition, the sixth pulse (not shown) is not skipped because the fifth reference pulse is smaller then the fifth PWM pulse.

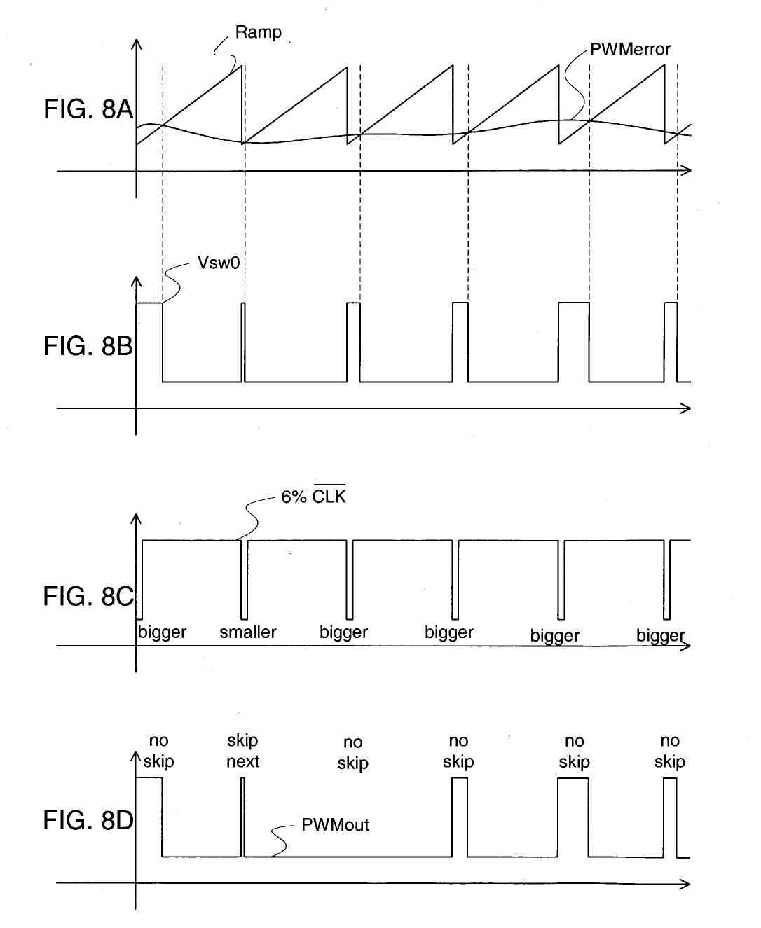

As FIGS. 7A-D illustrate the leading edge timing diagrams of the significant signals in controller 310, FIGS. 8A-D illustrate trailing edge timing diagrams. The time scales along FIGS. 8A-D are equivalent. FIG. 8A illustrates a timing diagram showing the ramp signal and the PWMerror signal. The ramp signal as produced by the oscillator 402 may be compared to the PWMerror signal produced by the comparator 403. FIG. 8B illustrates a PWM signal that is illustrative of what the comparator 403 would produce given the signals shown in FIG. 8A. The dashed lines connecting FIG. 8A to FIG. 8B show the logical transitions that the comparator 403 may produce, given the signals in FIG. 8A as inputs. The comparator 403 would produce these results if its input were reversed. For example, if the oscillator 402 was connected to the inverting input of the comparator 403 and the amplifier 401 was connected to the non-inverting input of amplifier 403.

FIG. 8C illustrates the inverted 6% CLK that the signal represented in FIG. 7B may be compared to. The text below each pulse states the results of this comparison. The first reference pulse is bigger, the second is smaller, the third is bigger, the fourth is bigger, the fifth is bigger and the sixth is bigger. FIG. 8D illustrates the signal PWMout, of a pulse-skipping controller as may be implemented by the present invention. The text above the waveform states the action that the controller takes given the results of the comparison between, the reference signal of FIG. 8C and the PWM signal of FIG. 8B. When the reference signal is smaller then the PWM signal then the next pulse is not skipped. When the reference signal is bigger then the PWM signal then the next pulse is skipped. The text in FIG. 8D illustrates this. For example, the second pulse is not skipped because the first reference pulse is smaller then the first PWM pulse. In addition, the third pulse is skipped because the second reference pulse is bigger then the second PWM pulse. In addition, the fourth pulse is not skipped because the third reference pulse is smaller then the third PWM pulse. In addition, the fifth pulse is not skipped because the fourth reference pulse is smaller then the fourth PWM pulse. In addition, the sixth pulse is not skipped because the fifth reference pulse is smaller then the fifth PWM pulse. In addition, the seventh pulse (not shown) is not skipped because the sixth reference pulse is smaller then the sixth PWM pulse.

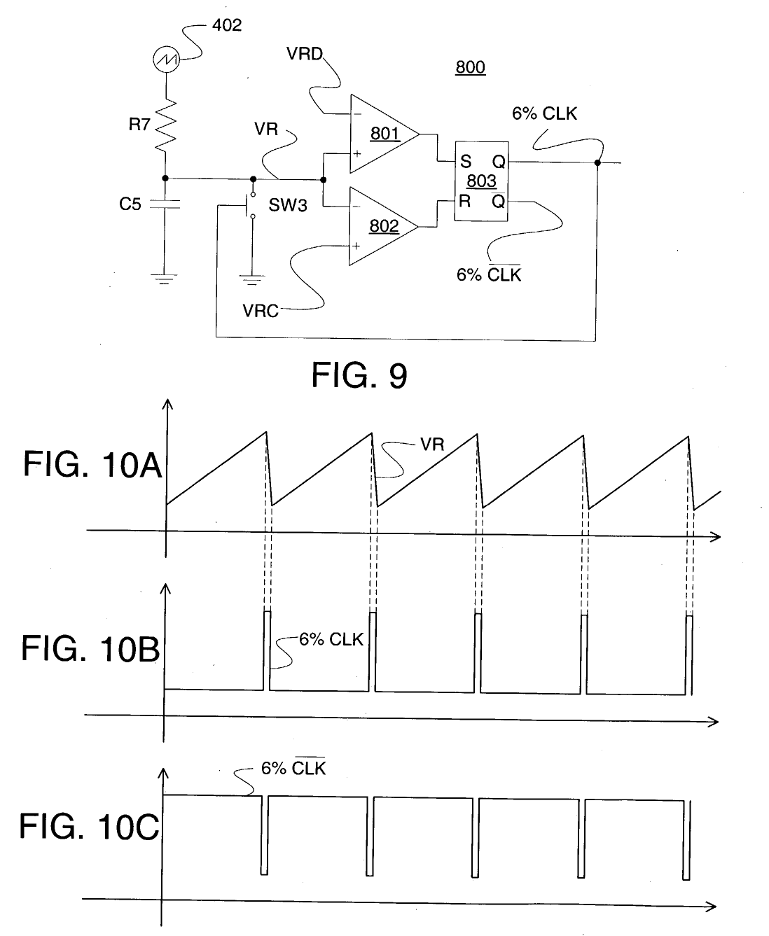

FIG. 9 illustrates a circuit for producing the inverted clock signal with a 6% duty cycle used by the controller 310 of FIG. 4. The oscillator 402, which may be identical to the oscillator 402 of FIG. 4, may produce a ramp signal, as shown in FIG. 4 and FIG. 7A. The oscillator 402 may be coupled to a first node of a resistor R7. A second node of the resistor R7 may form a signal VR that may be coupled to a first node of a capacitor C5, to a first node of a switch SW3, to an inverting input of a comparator 802, and to a non-inverting input of a comparator 801. A second node of the capacitor C5 may be coupled to a ground node. A second node of the switch SW3 may be coupled to a ground node. When SW3 is open, the signal VR will follow the ramp signal, limited by the RC filter made up of the resistor R7 and the capacitor C5, as shown in FIG. 10A. When SW3 is closed, the signal VR is coupled to a ground node.

A reference charge voltage VRC may be coupled to a non-inverting input of the comparator 802. A reference discharge voltage VRD may be coupled to an inverting input of the comparator 801. An output of the comparator 801 may be coupled to a SET input of a flip-flop 803. An output of the comparator 802 may be coupled to a RESET input of the flip-flop 803. The non-inverted output of the flip-flop 803 may be coupled to the control input of switch SW3. The non-inverted output of the flip-flop 803 may form a clock signal 6% CLK with a duty cycle that may have a nominal value of 6%, as shown in FIG. 10B, while the inverted output of the flip-flop 803 may form the inverted clock signal 6% \overline{CLK}with a duty cycle that may have a nominal value of 6%, as shown in FIG. 10C. When VR is greater then VRD then the SET input for flip-flop 803 is high, the 6% CLK is high and SW3 is closed causing the signal VR to be tied to ground. When VR is less then VRC then the RESET input for flip-flop 803 is high, the 6% CLK signal is low and SW3 is opened, causing signal VR to follow the ramp signal. When VR is greater then VRC but less then VRD then the 6% CLK signal remains constant. The duty cycle of the above clock signals may be adjusted by varying the reference voltages VRC, VRD or by varying the values of the components R7 and C5. The falling edge of the clock signal may be synchronized with the falling edge of the ramp signal.

FIG. 10A illustrates a timing diagram of the ramp signal as produced by oscillator 402. FIG. 10B illustrates a timing diagram of the 6% CLK signal as produced by flip-flop 803. FIG. 10C illustrates a timing diagram of the inverted 6% CLK signal as produced by flip-flop 803. Note that FIGS. 10A-C all share a time scale that is drawn along the horizontal axis.

While the foregoing has been in reference to particular embodiments of an aspect of the invention, it will be appreciated by those skilled in the art that changes in these embodiments may be made without departing from the principles and spirit of the invention, the scope of which is defined by the appended claims.

What is claimed is:

1. A two-stage power supply comprising:
a first power conversion stage; and
a second power conversion stage coupled to the first stage, wherein the power supply is operable in three regions, wherein in a first region switching in the first and second stages in enabled, and wherein in a second region the first stage is in a pulse-skipping mode of the first stage and the second stage is in a pulse-skipping mode of the second stage.

2. The two-stage power supply according to claim 1, wherein said first stage forms an intermediate output signal and wherein said first stage enters said pulse-skipping mode of the first stage when an error signal representative of a difference between the intermediate output signal and a desired level of the intermediate output signal crosses a threshold.

3. The two-stage power supply according to claim 2, wherein said first stage exits said pulse-skipping mode when the error signal re-crosses the threshold.

4. The two-stage power supply according to claim 2, wherein said first stage exits said pulse-skipping mode when the error signal re-crosses a level beyond the first threshold thereby exhibiting hysteresis.

5. The two-stage power supply according to claim 1 wherein a switching pulse width for the second stage is compared to a reference pulse width.

6. The two-stage power supply according to claim 5 wherein in said pulse-skipping mode of the second stage a next pulse is skipped based on whether the switching pulse width exceeds the reference pulse width.

7. The switching power converter, according to claim 5 wherein the reference clock has a 6% duty cycle.

8. The two-stage power supply according to claim 1 wherein in a third region switching in the first stage is disabled and the second stage is in the pulse-skipping mode of the second stage

9. The two-stage power supply according to claim 8 wherein said second stage forms a regulated output and wherein said third region is entered when a load coupled to receive the regulated output signals that it is in a standby mode.

10. The two-stage power supply according to claim 8 wherein the power supply further comprises an auxiliary power supply coupled to an output of the second stage and wherein when the power supply is in the third region the second stage is disabled and an auxiliary supply is enabled.

11. The two-stage power supply according to claim 10 wherein the auxiliary power supply comprises a linear converter.

12. The two-stage power supply according to claim 1 wherein in a third region switching in the first stage is disabled and switching in the second stage is disabled.

13. The two-stage power supply according to claim 12 wherein said second stage forms a regulated output and wherein said third region is entered when a load coupled to receive the regulated output signals that it is in a standby mode.

14. The two-stage power supply according to claim 12 wherein the power supply further comprises an auxiliary power supply coupled to an output of the second stage and wherein when the power supply is in the third region the second stage is disabled and an auxiliary supply is enabled.

15. The two-stage power supply according to claim 14 wherein the auxiliary power supply comprises a linear converter.

16. The two-stage power supply according to claim 1 wherein the first and second stages enter pulse-skipping mode when power drawn by a load is less than approximately 20% of a maximum expected level of power.

17. The two-stage power supply according to claim 1 wherein said third region is entered when power drawn by a load is less than approximately 0.5-1% of a maximum expected level of power.

18. The two-stage power supply according to claim 1 wherein the first stage provides power factor correction.

19. The two-stage power supply according to claim 1 wherein the second stage provides output current regulation.

20. The two-stage power supply according to claim 1 wherein the second stage provides output voltage regulation.

21. A system for controlling a power converter comprising:
means for forming an error signal that is representative of a difference between a reference signal and a sensed signal;
means for converting the error signal to a pulse-width modulation signal having a series of pulses wherein a width for each pulse is representative of a level of the error signal;
means for comparing the width of a pulse to a reference pulse width; and
means for skipping a next pulse in the series based on results of said comparison thereby entering pulse-skipping mode.

22. The system according to claim 21 wherein said sensed signal is representative of a level of an output signal of the power converter.

23. The system according to claim 22 wherein the means for converting comprises a comparator for comparing the pulse-width modulation signal to a periodic ramp signal.

24. The system according to claim 21 wherein the power converter comprises two stages.

25. The system according to claim 24 wherein a first stage of the power converter forms an intermediate signal delivered to a second stage of the power converter and wherein the second stage forms the output signal.

26. The system according to claim 25 further comprising means for comparing the intermediate signal to a desired level for the intermediate signal.

27. The system according to claim 24 further comprising means for disabling switching in said first stage in response to a level of said intermediate signal.

28. The system according to claim 21 further comprising means for entering a standby mode in which switching in the first stage is disabled.

29. The system according to claim 28 wherein said means for entering a standby mode comprises means for receiving a standby signal from a load.

30. The system according to claim 28 wherein the standby mode is entered when power drawn by a load is less than approximately 0.5-1% of a maximum expected level of power.

31. The system according to claim 25 further comprising means for entering a standby mode in which switching in the first and second stages is disabled.

32. The system according to claim 31 wherein said means for entering a standby mode comprises means for receiving a standby signal from a load.

33. The system according to claim 32 wherein the standby mode is entered when power drawn by a load is less than approximately 0.5-1% of a maximum expected level of power.

34. The system according to claim 31 further comprising means for enabling an auxiliary power supply in the standby mode.
